(19) United States
(12) Patent Application Publication
(10) Pub. No.: US 2025/0219434 A1
(43) Pub. Date: Jul. 3, 2025

(54) ENERGY STORAGE DEVICE AND RELATED OPERATION METHOD

(71) Applicant: Atemitech Corporation, Taoyuan City (TW)

(72) Inventor: Shih-Hung Yang, Taipei City (TW)

(21) Appl. No.: 18/646,749

(22) Filed: Apr. 25, 2024

(30) Foreign Application Priority Data
Jan. 3, 2024 (CN) 202410012013.4

(51) Int. Cl. H02J 7/00

(52) U.S. Cl. CPC H02J 7/007182; H02J 7/0063; H02J 2207/20

(57) ABSTRACT

An energy storage device includes a power line, a battery, a bidirectional switching circuit, a rectifying circuit and a processor. The power line uses an input voltage to supply power to the load. The bidirectional switching circuit includes a first transistor and a second transistor coupled between the power line and the battery in series sequentially. The first transistor and the second transistor are connected in a back-to-back manner. The rectifying circuit turns on when the input voltage is smaller than a voltage threshold to make the battery discharge to the power line through the second transistor and the rectifying circuit. The processor turns on the bidirectional switching circuit when the input voltage is smaller than the voltage threshold, so as to make the battery discharge to the power line through the first transistor and the second transistor.

### RELATED APPLICATIONS

This application claims priority to China Application Serial Number 202410012013.4, filed on Jan. 3, 2024, which is herein incorporated by reference in its entirety.

### BACKGROUND

### Technical Field

The present relates to a power supply technology. More specifically, the present disclosure relates to an energy storage device that can avoid abnormal discharge and a related operation method.

### Description of Related Art

With the increasing demand for remote work, remote teaching and the rise of artificial intelligence technology, the number of servers and total power of cloud data centers continue to increase. Therefore, most backup power supplies in data centers use backup battery units with instantaneous high-power discharge capabilities, and an input voltage supplied by transformer may be inputted to a server through backup battery units. However, even being operated normally, the input voltage may still vary in a finite range, and if the input voltage is lower than the discharge voltage of the backup battery unit, the backup battery unit may discharge abnormally and thereby inducing a loss on the stored electric energy.

### SUMMARY

The present disclosure provides an energy storage device, comprising a power line, a battery, a bidirectional switching circuit, a rectifying circuit and a processor. The power line is configured to be coupled to a load, and configured to receive an input voltage, so as to use the input voltage to supply power to the load. The bidirectional switching circuit comprises a first transistor and a second transistor coupled between the power line and the battery in series sequentially.

The first transistor and the second transistor are connected in a back-to-back manner. The rectifying circuit is coupled to the first transistor in parallel. The rectifying circuit is configured to be turned on in response to the input voltage being smaller than a voltage threshold, so as to make the battery discharge to the power line through the second transistor and the rectifying circuit. The processor is coupled to the bidirectional switching circuit. The processor is configured to turn on the bidirectional switching circuit in response to the input voltage being smaller than the voltage threshold, so as to make the battery discharge to the power line through the first transistor and the second transistor.

The present disclosure provides an operation method adapted to an energy storage device. The energy storage device comprises a power line, a battery, a bidirectional switching circuit, a rectifying circuit and a processor. The bidirectional switching circuit comprises a first transistor and a second transistor coupled between the power line and the battery in series sequentially, and the first transistor and the second transistor are connected in a back-to-back manner. The rectifying circuit is coupled to the first transistor in parallel. The operation method comprises: receiving an input voltage through the power line and using the input voltage to supply power to a load; in response to the input voltage being smaller than a voltage threshold, turning on the rectifying circuit, so as to make the battery discharge to the power line through the second transistor and the rectifying circuit; in response to the input voltage being smaller than the voltage threshold, utilizing the processor to turn on the bidirectional switching circuit, so as to make the battery discharge to the power line through the first transistor and the second transistor; and in response to the bidirectional switching circuit being turned on, turning off the rectifying circuit.

Some of advantages of the aforementioned energy storage device and operation method are compensating for the power shortage, reducing heat and preventing the battery from discharging abnormally.

### BRIEF DESCRIPTION OF THE DRAWINGS

FIG. 1 is a simplified functional block diagram of an energy storage device according to one embodiment of the present disclosure.

FIG. 2 is a flowchart of an operation method according to one embodiment of the present disclosure.

FIG. 3 is a simplified functional block diagram of an energy storage device according to one embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

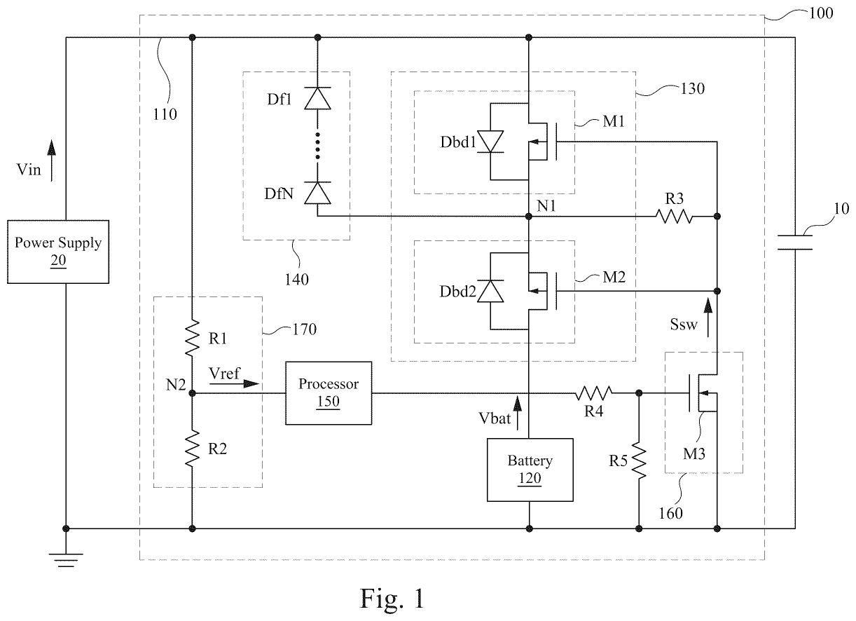

FIG. 1 is a simplified functional block diagram of an energy storage device 100 according to one embodiment of the present disclosure. The energy storage device 100 comprises a power line 110, a battery 120, a bidirectional switching circuit 130, a rectifying circuit 140, a processor 150, a control circuit 160, and a voltage-dividing circuit 170. The power line 110 is configured to be coupled to an external load 10, where the load 10 may be a combination of a memory and a memory controller in some embodiments. The power line 110 may be further configured to receive an input voltage Vin from an external power supply 20, so as to supply power to the load 10 using the input voltage Vin. The bidirectional switching circuit 130 comprises a first transistor M1 and a second transistor M2. The first transistor M1 and the second transistor M2 are coupled in series sequentially between the power line 110 and the battery 120, where the first transistor M1 and the second transistor M2 are connected in a back-to-back manner.

In the present embodiment, the first transistor M1 and the second transistor M2 may be implemented with P-type transistors, where “connected in a back-to-back manner” means that the first transistor M1 and the second transistor M2 are connected to each other through their source terminals. More specifically, a first terminal of the first transistor M1 (e.g., a drain terminal) is coupled to the power line 110, a second terminal of the first transistor M1 (e.g., a source terminal) is coupled to a body at a first node N1. A first terminal (e.g., the drain terminal) of the second transistor M2 is coupled to the battery 120. A second terminal (e.g., the source terminal) of the transistor M2 is coupled to the body at the first node N1. The first transistor M1 comprises a body diode Dbd1, and an anode and a cathode of the body diode Dbd1 are coupled to the power line 110 and the first node N1, respectively. The second transistor M2 comprises a body diode Dbd2, while the anode and the cathode of the body diode Dbd2 are coupled to the battery 120 and the first node N1, respectively.

The rectifying circuit 140 is coupled in parallel to the first transistor M1, and is configured to be turned on when the input voltage Vin is smaller than a voltage threshold, so as to make the battery 120 discharge to the power line 110 through the second transistor M2 (e.g., the body diode Dbd2 of the second transistor M2) and the rectifying circuit 140, and thereby keeping the load 10 to operate normally in a finite time period. The rectifying circuit 140 comprises N diodes Df1-DfN, where diodes Df1-DfN are coupled in series between the power line 110 and the first node N1, and N is a positive integer being larger than or equal to two. The aforementioned voltage threshold is correlated to threshold voltages of diodes Df1-DfN, a threshold voltage of the body diode Dbd2, and a discharge voltage of the battery 120 Vbat, where the voltage threshold may be derived from the following Formula 1.

Vth=Vbat−Vbd2−N×Vf (Formula 1)

In the aforementioned Formula 1, “Vth” represents the voltage threshold; “Vbd2” represents the threshold voltage of the body diode Dbd2; and “Vf” represents the threshold voltage of each of diodes Df1˜DfN. When the input voltage Vin is smaller than the voltage threshold, the battery 120 may discharge to the power line 110 through the body diode Dbd2 and diodes Df1-DfN. Since the discharge voltage Vbat may be determined by the connection method and the number of cores in the battery, and since the threshold voltage of the body diode Dbd2 and threshold voltages of diodes Df1-DfN bay be determined in the semiconductor manufacturing process, the voltage threshold may be determined in a circuit designing phase through Formula 1.

The processor 150 is coupled to the bidirectional switching circuit 130 through the control circuit 160. The processor 150 is configured to turn on the bidirectional switching circuit 130 when the input voltage Vin is smaller than the voltage threshold, so as to make the battery 120 discharge to the power line 110 through the first transistor M1 and the second transistor M2. More specifically, the voltage-dividing circuit 170 is coupled to the power line 110, and is configured to divide the input voltage Vin, so as to generate a reference voltage Vref. The voltage-dividing circuit 170 comprises a first resistor R1 and a second resistor R2, where the first resistor R1 and the second resistor R2 are coupled in series between the power line 110 and a ground terminal. The second node N2 between the first resistor R1 and the second resistor R2 is coupled to the processor 150, and the second node N2 is configured to generate the reference voltage Vref. The processor 150 is configured to determine the magnitude of the input voltage Vin according to the reference voltage Vref, and thereby determining a magnitude relationship between the input voltage Vin and the voltage threshold. As mentioned before, the voltage threshold is a parameter that may be determined in the circuit designing phase. Therefore, the voltage threshold may be stored in a memory of the processor 150 in advance.

It is worth mentioning that as the input voltage Vin being larger than or equal to the voltage threshold, the rectifying circuit 140 may be turned off automatically, and the processor 150 may turn off the bidirectional switching circuit 130. Therefore, the turned-off rectifying circuit 140, the turned-off second transistor M2, and the reverse-biased body diode Dbd2 may isolate the power line 110 from the battery 120.

The control circuit 160 is coupled to a control terminal (e.g., the gate terminal) of the first transistor M1 and a control terminal (e.g., the gate terminal) of the second transistor M2, and is coupled to the processor 150. The control circuit 160 is configured to output a switching signal Ssw, so as to control the first transistor M1 and the second transistor M2. The processor 150 is configured to control the control circuit 160 according to the magnitude relationship between the input voltage Vin and the voltage threshold, and thereby controlling the switching signal Ssw to switch between a first voltage level (e.g., a high voltage level) and a second voltage level (e.g., a low voltage level) that are different.

More specifically, the control circuit 160 comprises a third transistor M3, where the third transistor M3 is implemented with an N-type transistor in some embodiments. A first terminal (e.g., the drain terminal) of the third transistor M3 is configured to output the switching signal Ssw, and is coupled to the control terminal of the first transistor M1 and the control terminal of the second transistor M2. The first terminal of the third transistor M3 is further coupled to the third resistor R3 at the first node N1. A control terminal (e.g., the gate terminal) of the third transistor M3 is coupled to the processor 150 through the fourth resistor R4, so as to make the processor 150 control third transistor M3 according to the magnitude relationship between the input voltage Vin and the voltage threshold, and thereby controlling switching signal Ssw. The control terminal of the third transistor M3 may further be grounded through a fifth resistor R5. A second terminal (e.g., the source terminal) of the third transistor M3 is coupled to the ground terminal.

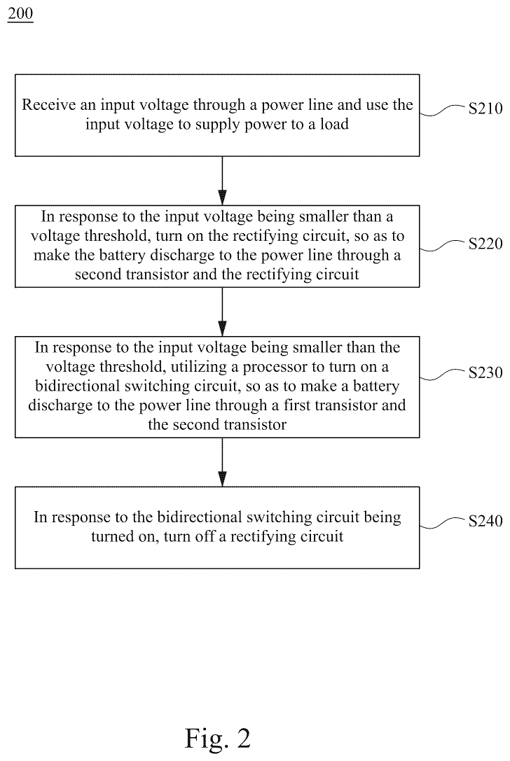

FIG. 2 is a flowchart of an operation method 200 according to one embodiment of the present disclosure, where the operation method 200 is adapted for the energy storage device 100 in FIG. 1. In step S210, the energy storage device 100 receives the input voltage Vin from the power supply 20 through the power line 110, and the power line 110 uses the input voltage Vin to supply power to the load 10.

In step S220, in response to the input voltage Vin being smaller than the voltage threshold, the rectifying circuit 140 may be turned on automatically, so as to make the battery 120 discharge to the power line 110 through the second transistor M2 (e.g., body diode Dbd2 of the second transistor M2) and the rectifying circuit 140. For example, the rectifying circuit 140 may be turned on when the power supply 20 is broken and is not able to supply the input voltage Vin, so as to make the battery 120 supply power to the load 10 in replace of the power supply 20.

In step S230, in response to the input voltage Vin being smaller than the voltage threshold, the processor 150 may turn on the bidirectional switching circuit 130, so as to make the battery 120 discharge to the power line 110 through the first transistor M1 and the second transistor M2. More specifically, the control circuit 160 may output the switching signal Ssw, so as to control the first transistor M1 and the second transistor M2. The voltage-dividing circuit 170 may generate the reference voltage Vref, and the processor 150 may determine the magnitude relationship between the input voltage Vin and the voltage threshold according to the reference voltage Vref, so as to control the switching signal Ssw to switch between the first voltage level (e.g., the high voltage level) and the second voltage level (e.g., the low voltage level) that are different.

More specifically, in step S230, the first terminal of the third transistor M3 in the control circuit 160 outputs the switching signal Ssw. The processor 150 controls the third transistor M3, so as to control the switching signal Ssw according to the magnitude relationship between the input voltage Vin and the voltage threshold. When the processor 150 determines that the input voltage Vin is smaller than the voltage threshold, the processor 150 may turn on the third transistor M3, so as to switch the switching signal Ssw from the first voltage level to the second voltage level, and thereby turning on the first transistor M1 and the second transistor M2.

In some embodiments, when the processor 150 determines that the input voltage Vin is larger than or equal to the voltage threshold, the processor 150 may turn off the third transistor M3 to keep the switching signal Ssw on the first voltage level, and thereby turning off the first transistor M1 and the second transistor M2. More specifically, the input voltage Vin may charge the control terminal of the first transistor M1 and the control terminal of the second transistor M2 through the body diode Dbd1 and the third resistor R3, and thereby keeping the switching signal Ssw on the first voltage level.

Then, in step S240, when the bidirectional switching circuit 130 is turned on, since the voltage on the power line 110 may approach the voltage on the first node N1, the rectifying circuit 140 may be turned off automatically.

It is worth mentioning that the rectifying circuit 140 has a faster response time with respect of the input voltage Vin than the bidirectional switching circuit 130, but the on-resistance of the rectifying circuit 140 is higher than that of the bidirectional switching circuit 130. Therefore, when the input voltage Vin is smaller than voltage threshold, the rectifying circuit 140 may be turned on to compensate for a power shortage timely in step S220, and then in step S230-S240, the bidirectional switching circuit 130 may be turned on, and the rectifying circuit 140 may be turned off, so as to reduce the heat produced by the discharging process. Therefore, the energy storage device 100 may not only compensate for the power shortage timely while reducing heat, but also prevent the battery 120 from discharging abnormally to the power line 110.

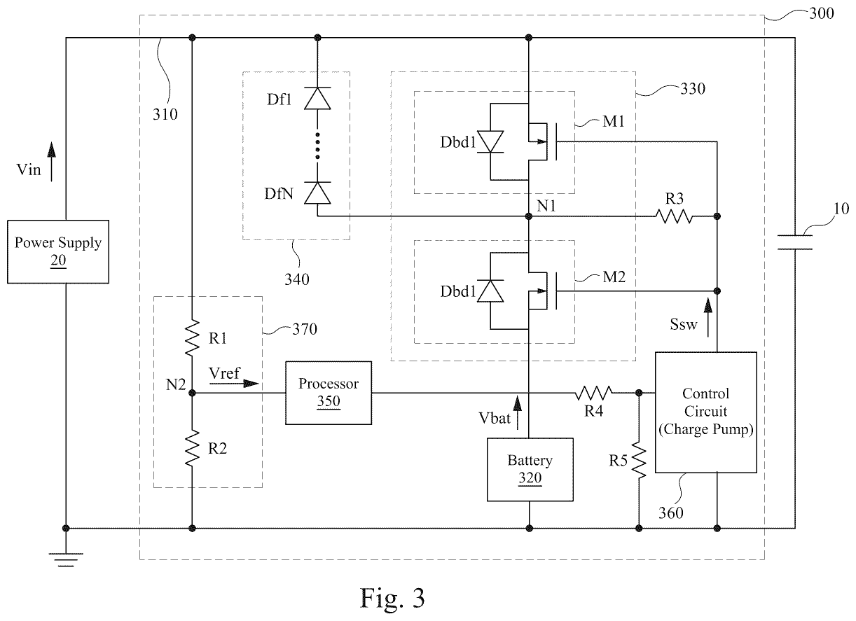

FIG. 3 is a simplified functional block diagram of an energy storage device 300 according to one embodiment of the present disclosure. The energy storage device 300 comprises a power line 310, a battery 320, a bidirectional switching circuit 330, a rectifying circuit 340, a processor 350, a control circuit 360, and a voltage-dividing circuit 370. The connection relationships, operations, and advantages of the power line 310, the battery 320, the rectifying circuit 340, the processor 350, and the control circuit 360 in FIG. 3 are similar to the power line 110, the battery 120, the rectifying circuit 140, the processor 150, and the control circuit 160 in FIG. 1, respectively. For simplicity, detail descriptions are omitted thereto.

In the present embodiment, a first transistor M1 and a second transistor M2 of the bidirectional switching circuit 330 are implemented with N-type transistors. A first terminal (e.g., the source terminal) of the first transistor M1 is coupled to a body through the power line 310. A second terminal (e.g., the drain terminal) of the first transistor M1 is coupled to the rectifying circuit 340 and the second transistor M2 through a first node N1. A first terminal (e.g., the source terminal) of the second transistor M2 is coupled to the body through the battery 320. A second terminal (e.g., the drain terminal) of the second transistor M2 is coupled to the first node N1. In other words, the first transistor M1 and the second transistor M2 are coupled in a back-to-back manner through their drain terminals.

In the present embodiment, the control circuit 360 is implemented with a charge pump. An output terminal of the charge pump is configured to generate a switching signal Ssw, and the output terminal of the charge pump is coupled to a control terminal (e.g., the gate terminal) of the first transistor M1 and the control terminal (e.g., the gate terminal) of the second transistor M2, and is further coupled to the ground terminal through a sixth resistor R6. The charge pump is further coupled to the processor 350, where the processor 350 is configured to control the charge pump, so as to control the switching signal Ssw according to a magnitude relationship between an input voltage Vin and a voltage threshold.

The energy storage device 300 may execute the operation method 200 depicted in FIG. 2. The difference from the content discussed with reference to FIG. 2 is that in the process of the energy storage device 300 executing step S230, the charge pump may generate the switching signal Ssw, and the processor 350 may control the charge pump, so as to control the switching signal Ssw according to the magnitude relationship between the input voltage Vin and the voltage threshold. More specifically, when the processor 150 determines that the input voltage Vin is smaller than voltage threshold, the processor 150 may enable the charge pump to charge the control terminal of the first transistor M1 and the control terminal of the second transistor M2. Therefore, the switching signal Ssw may switch from the second voltage level (e.g., the low voltage level) to the first voltage level (e.g., the high voltage level), and thereby turning on the first transistor M1 and the second transistor M2.

In some embodiments, when the processor 150 determines that the input voltage Vin is larger than or equal to the voltage threshold, the processor 150 may disable the charge pump to keep switching signal Ssw on the second voltage level, and thereby turning off the first transistor M1 and the second transistor M2. More specifically, the control terminal of the first transistor M1 and the control terminal of the second transistor M2 may discharge to the ground terminal through the sixth resistor R6, and thereby keeping the switching signal Ssw on the second voltage level.

To sum up, the energy storage device 300 may not only compensate for the power shortage timely while reducing heat, but also prevent the battery 320 from discharging abnormally to the power line 310.

Certain terms are used in the specification and the claims to refer to specific components. However, those of ordinary skill in the art would understand that the same components may be referred to by different terms. The specification and claims do not use the differences in terms as a way to distinguish components, but the differences in functions of the components are used as a basis for distinguishing. Furthermore, it should be understood that the term “comprising” used in the specification and claims is open-ended, that is, including but not limited to. In addition, “coupling” herein includes any direct and indirect connection means. Therefore, if it is described that the first component is coupled to the second component, it means that the first component can be directly connected to the second component through electrical connection or signal connections including wireless transmission, optical transmission, and the like, or the first component is indirectly electrically or signally connected to the second component through other component(s) or connection means.

It will be understood that, unless the context clearly dictates otherwise, the singular terms used herein include plural referents.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the present disclosure. In view of the foregoing, it is intended that the present disclosure cover modifications and variations of this disclosure provided they fall within the scope of the following claims and their equivalents.

What is claimed is:

1. An energy storage device, comprising:
a power line, configured to be coupled to a load, and configured to receive an input voltage, so as to use the input voltage to supply power to the load;
a battery;
a bidirectional switching circuit, comprising a first transistor and a second transistor coupled between the power line and the battery in series sequentially, wherein the first transistor and the second transistor are connected in a back-to-back manner;
a rectifying circuit, coupled to the first transistor in parallel, configured to be turned on in response to the input voltage being smaller than a voltage threshold, so as to make the battery discharge to the power line through the second transistor and the rectifying circuit; and
a processor, coupled to the bidirectional switching circuit, configured to turn on the bidirectional switching circuit in response to the input voltage being smaller than the voltage threshold, so as to make the battery discharge to the power line through the first transistor and the second transistor.

2. The energy storage device of claim 1, wherein the first transistor is coupled to the second transistor through a first node, and the rectifying circuit comprises:
N diodes, coupled between the power line and the first node in series, wherein N is a positive integer larger than or equal to two.

3. The energy storage device of claim 2, wherein the voltage threshold is equal to a difference of a discharge voltage of the battery minus N threshold voltages of the N diodes and a threshold voltage of a body diode of the second transistor.

4. The energy storage device of claim 1, further comprising:
a voltage-dividing circuit, coupled to the power line, configured to divide the input voltage to generate a reference voltage, wherein the processor is configured to receive the reference voltage, so as to determine a magnitude relationship between the input voltage and the voltage threshold according to the reference voltage.

5. The energy storage device of claim 1, further comprising:
a control circuit, coupled to a control terminal of the first transistor, a control terminal of the second transistor and the processor, configured to output a switching signal to control the first transistor and the second transistor, wherein the processor is configured to control the switching signal to switch between a first voltage level and a second voltage level that are different according to a magnitude relationship between the input voltage and the voltage threshold.

6. The energy storage device of claim 5, wherein the control circuit comprises:
a third transistor, comprising a first terminal, a second terminal and a control terminal,
wherein the first terminal of the third transistor is configured to output the switching signal, and is coupled to the control terminal of the first transistor and the control terminal of the second transistor,
wherein the second terminal of the third transistor is coupled to a ground terminal,
wherein the control terminal of the third transistor is coupled to the processor, and the processor is configured to control the third transistor to control the switching signal according to the magnitude relationship between the input voltage and the voltage threshold.

7. The energy storage device of claim 6, wherein the first transistor and the second transistor are P-type transistors, and a source terminal of the first transistor is coupled to a source terminal of the second transistor.

8. The energy storage device of claim 5, wherein the control circuit comprises:
a charge pump, configured to generate the switching signal, coupled to the processor, a control terminal of the first transistor and a control terminal of the second transistor,
wherein the processor is configured to control the charge pump to control the switching signal according to the magnitude relationship between the input voltage and the voltage threshold.

9. The energy storage device of claim 8, wherein the first transistor and the second transistor are N-type transistors, and a drain terminal of the first transistor is coupled to a drain terminal of the second transistor.

10. The energy storage device of claim 8, wherein the rectifying circuit is turned off in response to the bidirectional switching circuit being turned on.

11. An operation method, being adapted to an energy storage device, wherein the energy storage device comprises a power line, a battery, a bidirectional switching circuit, a rectifying circuit and a processor, wherein the bidirectional switching circuit comprises a first transistor and a second transistor coupled between the power line and the battery in series sequentially, and the first transistor and the second transistor are connected in a back-to-back manner, wherein the rectifying circuit is coupled to the first transistor in parallel, wherein the operation method comprises:
receiving an input voltage through the power line and using the input voltage to supply power to a load;
in response to the input voltage being smaller than a voltage threshold, turning on the rectifying circuit, so as to make the battery discharge to the power line through the second transistor and the rectifying circuit;
in response to the input voltage being smaller than the voltage threshold, utilizing the processor to turn on the bidirectional switching circuit, so as to make the battery discharge to the power line through the first transistor and the second transistor; and
in response to the bidirectional switching circuit being turned on, turning off the rectifying circuit.

12. The operation method of claim 11, wherein the first transistor is coupled to the second transistor through a first node, and the rectifying circuit comprises:
N diodes, coupled between the power line and the first node in series, wherein N is a positive integer larger than or equal to two.

13. The operation method of claim 12, wherein the voltage threshold is equal to a difference of a discharge voltage of the battery minus N threshold voltages of the N diodes and a threshold voltage of a body diode of the second transistor.

14. The operation method of claim 11, wherein the energy storage device further comprises a voltage-dividing circuit coupled to the power line, and in response to the input voltage being smaller than the voltage threshold, utilizing the processor to turn on the bidirectional switching circuit comprises:
utilizing the voltage-dividing circuit to divide the input voltage, so as to generate a reference voltage; and
utilizing the processor to determine a magnitude relationship between the input voltage and the voltage threshold according to the reference voltage.

15. The operation method of claim 11, wherein the energy storage device further comprises a control circuit, and the control circuit is coupled to a control terminal of the first transistor, a control terminal of the second transistor, and the processor, wherein in response to the input voltage being smaller than the voltage threshold, utilizing the processor to turn on the bidirectional switching circuit comprises:
utilizing the control circuit to output a switching signal so as to control the first transistor and the second transistor; and
utilizing the processor to control the switching signal to switch between a first voltage level and a second voltage level that are different according to a magnitude relationship between the input voltage and the voltage threshold.

16. The operation method of claim 15, wherein the control circuit comprises a third transistor, and the third transistor comprises a first terminal, a second terminal and a control terminal, wherein utilizing the control circuit to output the switching signal comprises:
utilizing the first terminal of the third transistor to output the switching signal, wherein the first terminal of the third transistor is coupled to the control terminal of the first transistor and the control terminal of the second transistor, the second terminal of the third transistor is coupled to a ground terminal, and the control terminal of the third transistor is coupled to the processor; and
utilizing the processor to control the third transistor to control the switching signal according to the magnitude relationship between the input voltage and the voltage threshold.

17. The operation method of claim 16, wherein the first transistor and the second transistor are P-type transistors, and a source terminal of the first transistor is coupled to a source terminal of the second transistor.

18. The operation method of claim 15, wherein the control circuit comprises a charge pump, and the charge pump is coupled to the processor, a control terminal of the first transistor, and a control terminal of the second transistor, wherein utilizing the control circuit to output the switching signal comprises:
utilizing the charge pump to generate the switching signal; and
utilizing the processor to control the charge pump to control the switching signal according to the magnitude relationship between the input voltage and the voltage threshold.

19. The operation method of claim 18, wherein the first transistor and the second transistor are N-type transistors, and a drain terminal of the first transistor is coupled to a drain terminal of the second transistor.
